(19) United States
(12) Patent Application Publication
(10) Pub. No.: US 2021/0035744 A1
(43) Pub. Date: Feb. 4, 2021

(54) MULTILAYER CERAMIC ELECTRONIC DEVICE

(71) Applicant: TAIYO YUDEN CO., LTD., Tokyo (JP)

(72) Inventors: Teruo ATSUMI, Tokyo (JP); Yoshiki IWAZAKI, Tokyo (JP)

(73) Assignee: TAIYO YUDEN CO., LTD., Tokyo (JP)

(21) Appl. No.: 16/945,460

(22) Filed: Jul. 31, 2020

(30) Foreign Application Priority Data
Aug. 1, 2019 (JP) 2019-142229

(51) Int. Cl. H01G 4/30; H01G 4/012; H01G 4/12; H01G 4/008

(52) U.S. Cl. CPC H01G 4/30; H01G 4/008; H01G 4/1218; H01G 4/012

(57) ABSTRACT

A multilayer ceramic device includes a ceramic main body including a plurality of internal electrodes laminated in a first direction, the ceramic main body having a pair of end surfaces respectively facing a second direction perpendicular to the first direction and a direction opposite to the second direction; a pair of protective layers covering respective entire areas of said pair of end surfaces, the protective layers each including at least one of Al, Si, Cr, Zn, Ga, Ge, In, Sn, W, Pt, Au and Bi as a main component thereof; and a pair of external electrodes respectively covering the pair of end surfaces through the pair of protective layers, respectively.

### BACKGROUND OF THE INVENTION

### Technical Field

The present invention relates to a multilayer ceramic electronic device having external electrodes.

### Background Art

Generally, in the manufacturing process of multilayer ceramic capacitors, a plating step for forming external electrodes is included. Hydrogen generated in the plating step tends to be stored in the external electrodes and remains there. In the multilayer ceramic capacitors, the hydrogen in the external electrodes diffuses into the ceramic main body, causing various harmful effects, such as degradation of the insulation resistance.

Patent Documents 1 and 2 disclose techniques to suppress the harmful effects of hydrogen in the external electrodes. In the technique disclosed in Patent Document 1, an opening for discharging hydrogen in the external electrodes is provided. In the technique disclosed in Patent Document 2, a protective layer made of TaN or TiN having a small diffusion constant for hydrogen is provided in order to prevent hydrogen diffusion.

### RELATED ART DOCUMENT

### Patent Document

Patent Document 1: Japanese Patent Application Laid-Open Publication No. 2013-110239
Patent Document 2: Japanese Patent Application Laid-Open Publication No. 2012-243998

### SUMMARY OF THE INVENTION

The present inventors found that by making a protective layer from a material selected from new perspectives, the harmful effects of the hydrogen in the external electrodes can be effectively suppressed. Using such a protective layer, it becomes possible to obtain a multilayer ceramic capacitor in which harmful effects due to diffusion of hydrogen in the external electrodes, such as a decrease in insulating resistance, can be suppressed.

In view of the foregoing, the present invention aims to provide a multilayer ceramic electronic device that is not susceptible to harmful effects of hydrogen in the external electrodes.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a multilayer ceramic device, comprising: a ceramic main body including a plurality of internal electrodes laminated in a first direction, the ceramic main body having a pair of end surfaces respectively facing a second direction perpendicular to the first direction and a direction opposite to the second direction; a pair of protective layers covering respective entire areas of said pair of end surfaces, the protective layers each including at least one of Al, Si, Cr, Zn, Ga, Ge, In, Sn, W, Pt, Au and Bi as a main component thereof; and a pair of external electrodes respectively covering the pair of end surfaces through the pair of protective layers, respectively.

In the above-described multilayer ceramic device, each of the external electrodes may include at least one plated film and/or may include at least one sputtered film next to and contacting the protective layer.

In the above-described multilayer ceramic device, each of the external electrodes may include at least one of Ni, Cu, Pd and Ag as a main component thereof.

In the above-described multilayer ceramic device, the ceramic main body further may have a pair of main surfaces respectively facing the first direction and a direction opposite to the first direction, and a pair of side surfaces respectively facing a third direction that is perpendicular to the first and second directions and a direction opposite to the third direction, and the pair of protective layers and the pair of external electrodes may respectively extend from the end surfaces to the main surfaces and to the side surfaces.

The present inventors conceived that by providing a protective layer configured to block hydrogen, hydrogen can be blocked without embrittlement due to hydrogen absorption. The present inventors identified atomic elements that have hydrogen blocking effects based on hydrogen stabilization energy E(H), and realized a protective layer that can block hydrogen using these elements.

According to the present invention, a multilayer ceramic electronic device that is not susceptible to harmful effects of hydrogen in external electrodes can be obtained.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a perspective view of a multilayer ceramic capacitor according to an embodiment of the present invention.

FIG. 2 is a cross-sectional view of the multilayer ceramic capacitor taken along the line A-A′ of FIG. 1.

FIG. 3 is a cross-sectional view of the multilayer ceramic capacitor taken along the line B-B′ of FIG. 1.

FIG. 4 is a graph showing the hydrogen stabilization energy E(H) calculated for various atomic elements.

FIG. 5 is a cross-sectional view of a multilayer ceramic capacitor according to another embodiment of the present invention.

FIG. 6 is a flowchart showing a manufacture method of the multilayer ceramic capacitors.

FIG. 7 is an exploded perspective view of a ceramic main body in step S01 of FIG. 6.

FIG. 8 is a perspective view of the ceramic main body obtained in step S02 of FIG. 6.

FIG. 9 is a cross-sectional view in step S03.

FIG. 10 is a cross-sectional view in step S04.

FIG. 11 is a cross-sectional view in step S04.

### DETAILED DESCRIPTION OF EMBODIMENTS

Embodiments of the present invention will be described with reference to drawings. In the drawings, the X-axis, Y-axis, and the Z-axis, which are perpendicular to each other, are indicated whenever appropriate. These axes are oriented in the same way in all of the drawings.

<Main Structure of Multilayer Ceramic Capacitor 10>

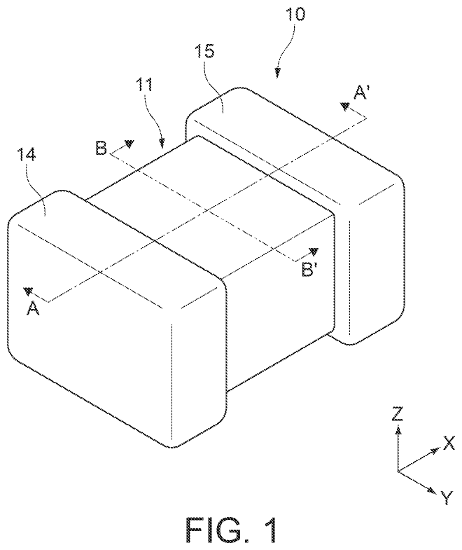

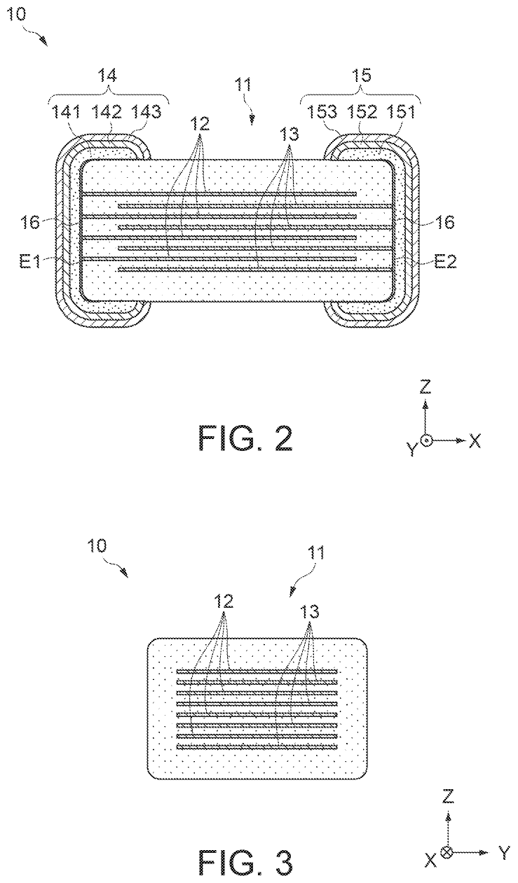

FIGS. 1-3 show a multilayer ceramic capacitor 10 according to an embodiment of the present invention. FIG. 1 is a perspective view of the multilayer ceramic capacitor 10. FIG. 2 is a cross-sectional view of the multilayer ceramic capacitor 10 taken along the line A-A′ of FIG. 1. FIG. 3 is a cross-sectional view of the multilayer ceramic capacitor 10 taken along the line B-B′ of FIG. 1.

The multilayer ceramic capacitor 10 includes a ceramic main body 11, a first external electrode 14, a second external electrode 15, and protective layers 16. The outer surfaces of the ceramic main body 11 are: first and second end surfaces E1 and E2 respectively facing the negative X-direction and positive X-direction; the first and second side surfaces respectively facing the negative and positive Y-directions; and first and second main surfaces respectively facing the positive Z-direction and the negative Z-direction.

The ceramic main body 11 has ridge parts, which respectively connect the first and second end surfaces, the first and second side surfaces, and the first and second main surfaces with each other and which are chamfered and thereby rounded by barrel polishing or the like. Alternatively, the ridge parts may be non-chamfered ridge parts that directly connect the corresponding respective surfaces.

The protective layers 16 respectively cover the first and second end surfaces E1 and E2 of the ceramic main body 11. In the multilayer ceramic capacitor 10, the protective layers 16 protect the ceramic main body 11 from harmful effects due to hydrogen stored in the external electrodes 14 and 15. The details of the protective layers 16 will be described further below.

The first external electrode 14 covers the first end surface E1 of the ceramic main body 11 through the protective layer 16. The second external electrode 15 covers the second end surface E2 of the ceramic main body 11 through the protective layer 16. The external electrodes 14 and 15 are opposite to each other along the X-axis and function as terminals of the multilayer ceramic capacitor 10.

The external electrodes 14 and 15 respectively extend from the end surfaces E1 and E2 of the ceramic main body 11 to the main surfaces and to the side surfaces, and are separated from each other on the main surfaces and on the side surfaces. Therefore, the external electrodes 14 and 15 are both U-shaped in the cross sections parallel to the X-Z plane shown in FIG. 2 and in the cross sections parallel to the X-Y plane.

The shape of the external electrodes 14 and 15 is not limited to that shown in FIGS. 1 and 2. For example, the external electrodes 14 and 15 may respectively extend from the end surfaces E1 and E2 to one of the main surfaces only, and therefore may have an L-shape in cross sections parallel to the X-Z plane. Moreover, the external electrodes 14 and 15 may not have to extend to any of the main surfaces and side surfaces.

The first external electrode 14 has a three-layered structure including an undercoat film 141, an intermediate film 142 and a surface film 143. The undercoat film 141 is attached to the outer surface of the protective layer 16 and constitutes the innermost layer of the first external electrode 14. The surface film 143 constitutes the outermost layer of the first external electrode 14. The intermediate layer 142 is disposed between the undercoat film 141 and the surface film 143.

The second external electrode 15 has a three-layered structure including an undercoat film 151, an intermediate film 152 and a surface film 153. The undercoat film 151 is attached to the outer surface of the protective layer 16 and constitutes the innermost layer of the first external electrode 15. The surface film 153 constitutes the outermost layer of the first external electrode 15. The intermediate layer 152 is disposed between the undercoat film 151 and the surface film 153.

The undercoat films 141 and 151 are made of a metal having at least one of nickel (Ni), copper (Cu), palladium (Pd), and silver (Ag) as its main component or their alloy, for example. The undercoat films 141 and 151 may be at least one layer of a sputtered film made by sputtering, or at least one layer of a baked film made by coating and baking an electrically conductive paste. Or, the undercoat films 141 and 151 may be formed by combining a sputtered film and a baked film.

The intermediate films 142 and 152 and the surface films 143 and 153 may be made of a metal having at least one of Ni, Cu, Sn (tin), Pd, and Ag as the main component or their alloy. The undercoat films 142 and 152 and the surface films 143 and 153 may be a plated film that is made by a wet plating method, for example.

The ceramic main body 11 is made of a ceramic dielectric. The ceramic main body 11 includes a plurality of first internal electrodes 12 and second internal electrodes 13 covered by the ceramic dielectric. The plurality of internal electrodes 12 and 13 each have a sheet-like shape extending in the X-Y plane, and are laminated alternately in the Z-direction.

That is, in the ceramic main body 11, an electrode facing region in which the internal electrodes 12 and 13 face each other along the Z-direction with the ceramic layers in between is formed. The first internal electrodes 12 extend from the electrode facing region to the first end surface E1, and are connected to the first external electrode 14. The second internal electrodes 13 extend from the electrode facing region to the second end surfaced E2, and are connected to the second external electrode 15.

With this structure, in the multilayer ceramic capacitor 10, when voltage is applied between the first external electrode 14 and the second external electrode 15, the voltage is applied to the plurality of ceramic layers in the electrode facing region of the internal electrodes 12 and 13. Because of this, in the multilayer ceramic capacitor 10, electric charges corresponding to the voltage between the first external electrode 14 and the second external electrode 15 are stored.

In the ceramic main body 11, in order to increase the capacitance of each of the ceramic layers between the internal electrodes 12 and 13, a high permittivity ceramic dielectric is used. Such a ceramic dielectric having a high permittivity may be a perovskite material that includes barium (B a) and titanium (Ti), exemplified by barium titanate (BaTiO₃).

Here, the ceramic dielectric may be the strontium titanate (SrTiO₃) system; the calcium titanate (CaTiO₃) system; the magnesium titanate (MgTiO₃) system; the calcium zirconate (CaZrO₃) system; the calcium titanate zirconate (Ca(Zr, Ti)O₃) system; the barium zirconate (BaZrO₃) system; and the titanium dioxide (TiO₂) system instead.

<Detailed Structure of Protective Layers 16>

The external electrodes 14 and 15 of the multilayer ceramic capacitor 10 tend to absorb and store hydrogen. Especially when the intermediate film 142 and 152 and the surface films 143 and 153 are made by a wet-plating method (especially by electroplating), which generates hydrogen, a large amount of hydrogen tends to be stored in the external electrodes 14 and 15.

The hydrogen absorbed and stored in the external electrodes 14 and 15 is not limited to the hydrogen generated in the plating process, and may be hydrogen in water, such as water vapor in the atmosphere. Also, the hydrogen absorbed and stored in the external electrodes 14 and 15 may take any form of hydrogen, such as hydrogen atoms, hydrogen ions, and hydrogen isotope.

Hydrogen is an element that has strong degrading effects on the ceramic main body 11. Because of this, if hydrogen absorbed and stored in the external electrodes 14 and 15 diffuses and reaches the electrode facing region of the internal electrodes 12 and 13, the insulation resistance of the ceramic layers between the internal electrodes 12 and 13 decreases. If that occurs in the multilayer ceramic capacitor 10, insulation defects are likely to occur.

In the multilayer ceramic capacitor 10 of the present embodiment, the protective layers 16 are provided to prevent the hydrogen absorbed and stored in the external electrodes 14 and 15 from diffusing into the ceramic main body 11 from the end surfaces E1 and E2. That is, by covering the end surfaces E1 and E2 of the ceramic main body 11, the protective layers 16 protect the ceramic main body 11 from hydrogen in the external electrodes 14 and 15.

In more detail, the protective layers 16 have the function of blocking hydrogen. Because the hydrogen in the external electrodes 14 and 15 is blocked by the protective layer 16, intrusion of hydrogen into the ceramic main body 11 from the end surfaces E1 and E2 can be prevented. Therefore, in the multilayer ceramic capacitor 10, diffusion of hydrogen into the ceramic main body 11 can be prevented.

Further, because of the hydrogen blocking property, the protective layers 16 do not absorb hydrogen much. Accordingly, at the protective layers 16, embrittlement due to absorption of hydrogen is unlikely to occur. That is, an increase in electrical resistance and/or mechanical strength degradation due to the embrittlement are unlikely to occur. Because of this, in the multilayer ceramic capacitor 10, troubles due to the deterioration of the protective layers 16 are unlikely to occur.

In the present embodiment, in order to achieve the function of blocking hydrogen at the protective layers 16, an atomic element that has the function of blocking hydrogen is used as the main component of the protective layers 16. For that purpose, the present inventors have identified atomic elements that have the function of blocking hydrogen based on the hydrogen stabilization energy E(H). The hydrogen stabilization energy E(H) is defined by the following formula for each atomic element.

E(H)=E(crystal)+½E(H₂)−E(crystal+H)

Here, E(crystal) is calculated as an energy of crystal that is empirically stable for each element. E(H₂) is calculated as an energy of hydrogen gas. E(crystal+H) is calculated as an energy of crystal inserted with hydrogen atom.

In the above formula, (E(crystal)+½E(H₂)) is the total energy of the crystal structure that is not storing hydrogen and hydrogen. That is, among atomic elements, the higher the stability of the condition of not containing hydrogen, the smaller the value of (E(crystal)+½E(H₂)).

On the other hand, E(crystal+H) represents an energy of a crystal structure that assumes the condition in which hydrogen is absorbed and stored in the crystal. Therefore, among atomic elements, the higher the stability of the condition of containing hydrogen, the smaller the value of E(crystal+H).

That is, the greater the hydrogen stabilization energy E(H) of an element, the higher the stability of the condition in which hydrogen is absorbed and stored in the crystal for that element. In contrast, the smaller the hydrogen stabilization energy E(H) for an element, the higher the stability of the condition in which hydrogen is not absorbed or stored in the crystal for that element. Here, minus values of the hydrogen stabilization energy E(H) are regarded as “smaller” as used herein when the absolute values thereof are larger.

The inventors have realized that if the stability of the condition in which hydrogen is not absorbed or stored in the crystal is high—i.e., if the hydrogen stabilization energy E(H) is small, such an element has a stronger effect of blocking hydrogen. Therefore, for the protective layers 16, atomic elements that have low hydrogen stabilization energy E(H) values should be used.

Using the above-described formula, the hydrogen stabilization energy E(H) was calculated for various atomic elements. Table 1 below shows the hydrogen stabilization energy E(H) for each element. In Table 1, for elements having plural crystal structures that are empirically stable, the hydrogen stabilization energy E(H) of each of such structures are shown. Also, in the “Crystal Structure” column of Table 1, “hcp” means the hexagonal closed-packed structure, “bcc” means the body-centered cubic lattice, and “fcc” means the face-centered cubic lattice.

TABLE 1

| Element | Crystal Structure | E (H) (eV) |
|---|---|---|
| Al | fcc | −0.47 |
| Si | Diamond | −1.55 |
| Sc | hcp | 1.04 |
| | bcc | 0.97 |
| | fcc | 0.97 |
| Ti | hcp | 0.58 |
| | bcc | 0.91 |
| V | bcc | 0.38 |
| Cr | bcc | −0.66 |
| Mn | bcc | 0.22 |
| Fe | bcc | −0.32 |
| | hcp | −0.06 |
| | fcc | 0.05 |
| Co | hcp | −0.04 |
| | fcc | 0.05 |
| Ni | fcc | 0.25 |
| Cu | fcc | 0.05 |
| Zn | hcp | −0.84 |
| Ga | Orthorhombic | −0.63 |
| | Orthorhombic | −0.92 |
| | Orthorhombic | −0.54 |
| Ge | Diamond | −1.68 |
| Zr | hcp | 0.56 |
| | bcc | 0.62 |
| | fcc | 0.80 |
| Nb | bcc | 0.61 |
| Ru | hcp | −0.19 |
| Pd | fcc | 0.38 |
| Ag | fcc | −0.24 |
| In | fcc | −0.78 |
| | bcc | −0.71 |
| Sn | β - Sn | −0.76 |
| | α - Sn | −1.38 |
| Hf | hcc | 1.10 |
| | bcc | 1.17 |
| Ta | α - Ta | 0.32 |
| | β - Ta | 0.29 |
| W | bcc | −0.94 |
| Pt | fcc | −0.48 |
| Au | bcc | −0.50 |
| Bi | Trigonal | −1.02 |

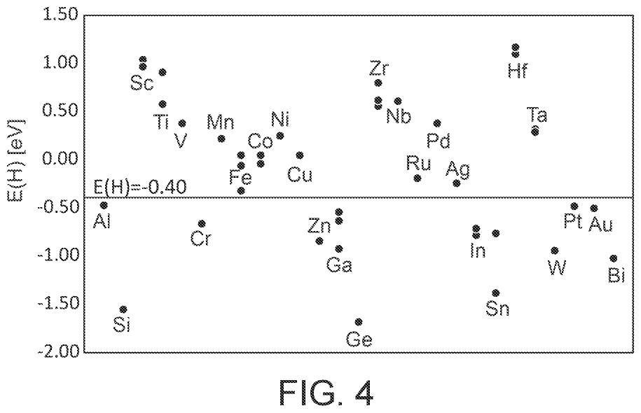

FIG. 4 is a graph plotting the hydrogen stabilization energy E(H) for each element shown in Table 1. FIG. 4 also shows a horizontal line at E(H)=−0.40 (eV). In this embodiment, by using an element that is plotted below this line as the main component of the protective layer 16, the protective layer 16 can block hydrogen.

That is, in the multilayer ceramic capacitor 10, as the main component of the protective layers 16, at least one elements among the elements having the hydrogen stabilization energy E(H) of less than −0.40 eV, which are specifically: Al (aluminum), Si (silicon), Cr (chromium), Zn (zinc), Ga (gallium), Ge (germanium), In (indium), Sn, W (tungsten), Pt (platinum), Au (gold), and Bi (bismuth), is used.

In the multilayer ceramic capacitor 10, hydrogen in the external electrodes 14 and 15 is blocked by the protective layers 16 and is returned to the external electrodes 14 and 15. Therefore, with the protective layers 16, hydrogen tends to stay longer in the external electrodes 14 and 15, as compared with the case of using protective layers that absorb and capture hydrogen.

In the multilayer ceramic capacitor 10, the protective layers 16 are provided on the entire areas of the end surfaces E1 and E2 of the ceramic main body 11. That is, in the multilayer ceramic capacitor 10, the external electrodes 14 and 15 that contain hydrogen and the end surfaces E1 and E2 of the ceramic main body 11 are separated from each other by the protective layers 16, respectively, throughout the entire areas of the respective end surfaces E1 and E2.

Because of this, in the ceramic main body 11, diffusion of hydrogen can be prevented through the entire areas of the end surfaces E1 and E2. That is, in the ceramic main body 11, not only hydrogen diffusion from the respective center regions of the end surfaces E1 and E2 that are close to the electrode facing region of the internal electrodes 12 and 13, but also hydrogen diffusion from the peripheral regions of the end surfaces E1 and E2 that are far from the electrode facing region of the internal electrodes 12 and 13 can be prevented.

Therefore, even if hydrogen stays in the external electrodes 14 and 15 for a long time, hydrogen is unlikely to diffuse into the ceramic main body 11 and reach the electrode facing region of the internal electrodes 12 and 13. Thus, in the multilayer ceramic capacitor 10, a decrease in the insulation resistance due to hydrogen in the external electrodes 14 and 15 can be prevented.

Further, in the multilayer ceramic capacitor 10, as shown in FIG. 2, it is preferable that the protective layers 16 go around the ridge parts that respectively connect the end surfaces E1 and E2 of the ceramic main body 11 to the side surfaces and the main surfaces thereof. With this structure of the multilayer ceramic capacitor 10, diffusion of hydrogen in the external electrodes 14 and 15 into the ceramic main body 11 through the respective ridge parts can be prevented.

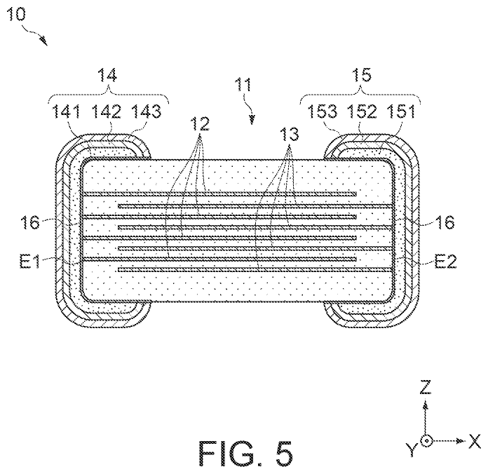

Furthermore, in the multilayer ceramic capacitor 10, as shown in FIG. 5, it is further preferable that the protective layers 16 go around to the side surfaces and the main surfaces from the end surfaces E1 and E2 of the ceramic main body 11. With this structure of the multilayer ceramic capacitor 10, diffusion of hydrogen in the external electrodes 14 and 15 into the ceramic main body 11 through the respective side surfaces and main surfaces can be prevented.

It is important that in the multilayer ceramic capacitor 10, the protective layers 16 are provided directly on the ceramic main body 11 that is the object with respect to which hydrogen diffusion should be prevented. Specifically, if, for example, the protective layers 16 are provided between the undercoat films 141 and 151 and the intermediate films 142 and 152 of the external electrodes 14 and 15, respectively, the above-mentioned effects may be not sufficiently obtained.

That is, if the protective layers 16 were provided at the outer sides of the undercoat films 141 and 151, hydrogen absorbed and stored in the undercoat films 141 and 151 would be trapped on inner sides of the protective layers 16, which have the function of blocking hydrogen. Because of this, hydrogen in the undercoat films 141 and 151 cannot escape to the external space, thereby undesirably promoting hydrogen diffusion from the end surfaces E1 and E2 of the ceramic main body 11.

<Manufacture Method of Multilayer Ceramic Capacitor 10>

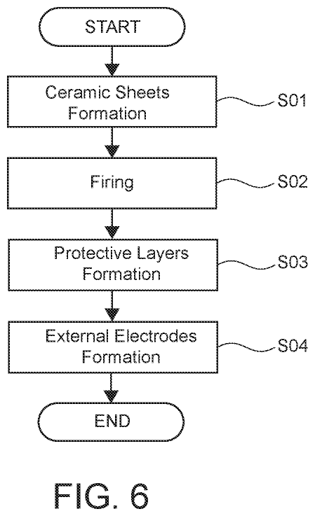

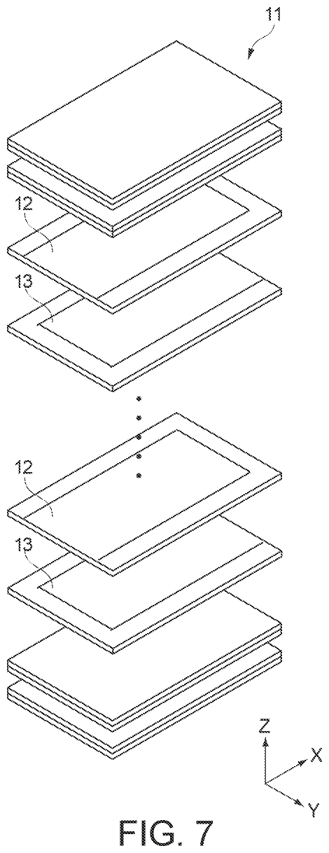

FIG. 6 is a flowchart of a manufacture method of the multilayer ceramic capacitor 10. FIGS. 7-11 show process steps of the multilayer ceramic capacitor 10. Below, a manufacture method of the multilayer ceramic capacitor 10 will be explained along FIG. 6 with reference to FIGS. 7 to 11.

<Step S01: Ceramic Sheets Formation>

At step S01, a ceramic main body 11 that is yet to be fired is formed. As shown in FIG. 7, the ceramic main body 11 yet to be fired is obtained by laminating and thermocompression-bonding a plurality of ceramic sheets in the Z-direction. By printing electrically conductive pastes having prescribed patterns on the ceramic sheets, internal electrodes 12 and 13 can be disposed.

The ceramic sheets are green sheets that are yet to be fired, formed by molding a ceramic slurry into a sheet shape. The ceramic sheets may be formed into a sheet shape by a roll coater, or doctor blade, for example. The main component of the ceramic slurry is adjusted so that the ceramic main body 11 of desired compositions can be obtained.

<Step S02: Firing>

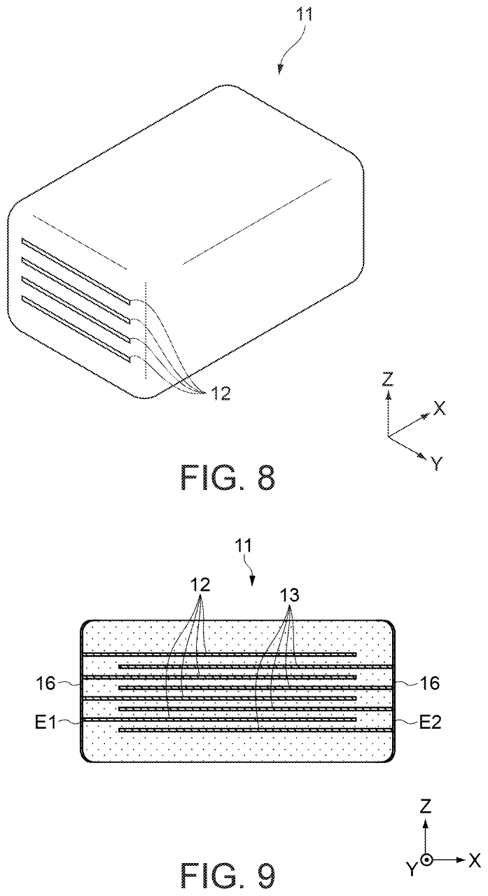

At step S02, the ceramic main body 11 yet to be fired, obtained in step S01 is fired. As a result, the ceramic main body 11 is sintered and the ceramic main body 11 shown in FIG. 8 is obtained. The firing of the ceramic main body 11 may be performed in a reducing atmosphere or low oxygen partial pressure atmosphere. The firing temperature of the ceramic main body can be appropriately determined.

<Step S03: Protection Layers Formation>

At step S03, as shown in FIG. 9, the protective layers 16 are formed on the end surfaces E1 and E2 of the ceramic main body 11 obtained in step S02. For the formation of the protective layers 16, a method other than a wet-plating method that accompanies hydrogen generation can be used. For example, sputtering or vapor evaporation can be used.

<Step S04: External Electrodes Formation>

At step S04, external electrodes 14 and 15 are formed on the ceramic main body 11 that has been formed with the protective layers 16 in step S03. This completes the multilayer ceramic capacitor 10 shown in FIGS. 1-3. Specifically, at step S04, the undercoat films 141 and 151, the intermediate films 142 and 152, and the surface films 143 and 153 are formed.

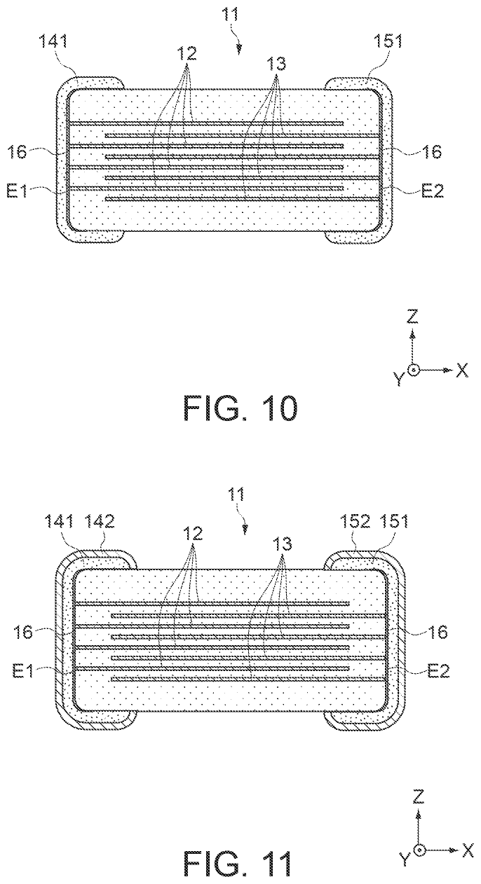

First, as shown in FIG. 10, the undercoat films 141 and 151 are formed on the ceramic main body 11 so as to cover the protective layers 16 formed in step S03. To form the undercoat films 141 and 151, a sputtering method or a baking method in which an electrically conductive paste is baked onto the ceramic main body 11 can be used, for example.

Here, if the element constituting the main component of the protective layers 16 is likely to diffuse into the ceramic main body 11, in order to maintain the protective layers 16, it is preferable not to perform a heat treatment process for the formation of the external electrodes 14 and 15. From this perspective, it is preferable to use the sputtering method, rather than the baking method, in the formation of the undercoat films 141 and 151.

Next, as shown in FIG. 11, the intermediate films 142 and 152 are formed on the undercoat films 141 and 151 provided on the ceramic main body 11. Further, the surface films 143 and 153 are formed on the intermediate films 142 and 152, thereby completing the external electrodes 14 and 15 shown in FIGS. 1 and 2. For the formation of the intermediate films 142 and 152 and the surface films 143 and 153, a wet-plating method can be used, for example.

In the wet-plating method (especially electroplating), hydrogen is generated in that process, and the generated hydrogen enters into the undercoat films 141 and 151, the intermediate films 142 and 152, and the surface films 134 and 153. However, in the ceramic main body 11 covered by the protective layers 16, the entering of hydrogen form the end surfaces E1 and E2 is prevented.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

For example, in the present invention, the structure of the external electrodes is not limited to the three-layered structure described above. It may be a single layer structure, double layer structure, or four or more layered structure. The structure of having protective layers of the present invention is especially effective when the external electrodes contain at least one layer of a plated film formed by a wet-plating method. But the external electrodes do not have to contain such a metal layer.

Further, the present invention is applicable to not only multilayer ceramic capacitors, but also multilayer ceramic electronic devices having external electrodes in general. Such multilayer ceramic electronic devices include, for example, chip varistors, chip thermistors, multilayer inductors, etc.

What is claimed is:

1. A multilayer ceramic device, comprising:
a ceramic main body including a plurality of internal electrodes laminated in a first direction, the ceramic main body having a pair of end surfaces respectively facing a second direction perpendicular to the first direction and a direction opposite to the second direction;
a pair of protective layers covering respective entire areas of said pair of end surfaces, the protective layers each including at least one of Al, Si, Cr, Zn, Ga, Ge, In, Sn, W, Pt, Au and Bi as a main component thereof; and
a pair of external electrodes respectively covering the pair of end surfaces through the pair of protective layers, respectively.

2. The multilayer ceramic device according to claim 1, wherein each of the external electrodes includes at least one plated film.

3. The multilayer ceramic device according to claim 2, wherein each of the external electrodes includes at least one sputtered film next to and contacting the protective layer.

4. The multilayer ceramic device according to claim 1, wherein each of the external electrodes is made of a multilayer film that includes at least one plated film and at least one sputtered film.

5. The multilayer ceramic device according to claim 1, wherein each of the external electrodes includes at least one of Ni, Cu, Pd and Ag as a main component thereof.

6. The multilayer ceramic device according to claim 1,
wherein the ceramic main body further has a pair of main surfaces respectively facing the first direction and a direction opposite to the first direction, and a pair of side surfaces respectively facing a third direction that is perpendicular to the first and second directions and a direction opposite to the third direction, and
wherein the pair of protective layers and the pair of external electrodes respectively extend from the end surfaces to the main surfaces and to the side surfaces.
